(19) United States
(12) Patent Application Publication
(10) Pub. No.: US 2015/0205006 A1
(43) Pub. Date: Jul. 23, 2015

(54) DOWNHOLE MODELING USING INVERTED PRESSURE AND REGIONAL STRESS

(71) Applicant: Schlumberger Technology Corporation, Sugar Land, TX (US)

(72) Inventors: Frantz Maerten, Grabels (FR); Laurent Maerten, Grabels (FR); Mustapha Lejri, Grabels (FR)

(21) Appl. No.: 14/611,485

(22) Filed: Feb. 2, 2015

Related U.S. Application Data
(63) Continuation-in-part of application No. 13/052,327, filed on Mar. 21, 2011.
(60) Provisional application No. 61/317,412, filed on Mar. 25, 2010.

(30) Foreign Application Priority Data
Mar. 31, 2014 (FR) 1452777

(51) Int. Cl. G01V 99/00; G06F 17/11; G06F 17/50

(52) U.S. Cl. CPC G01V 99/005; G06F 17/5009; G06F 17/11

(57) ABSTRACT

Systems and methods for predicting a stress attribute of a subsurface earth volume. One or more linearly independent far field stress models and one or more discontinuity pressure models may be simulated for the subsurface earth volume to generate stress values, strain values, displacement values, or a combination thereof for data points in the subsurface earth volume. A processor may be used to compute a superposition of the one or more linearly independent far field stress models and the one or more discontinuity pressure models. The stress attribute of the subsurface earth volume may be predicted, based on the computed stress values, strain values, displacement values, or the combination thereof.

### CROSS-REFERENCE TO RELATED APPLICATIONS

This application is a continuation-in-part of U.S. patent application Ser. No. 13/052,327, filed on Mar. 21, 2011, which claims priority to U.S. Provisional Patent Application Serial No. 61/317,412, filed on Mar. 25, 2010. The entirety of each of these priority patent applications is incorporated by reference herein.

### BACKGROUND

A fault may be considered a finite complex three-dimensional surface discontinuity in a volume of earth or rock. Fractures, such as joints, veins, dikes, pressure solution seams with stylolites, and so forth, may be propagated intentionally, to increase permeability in formations such as shale, in which optimizing the number, placement, and size of fractures in the formation increases the yield of resources like shale gas.

Stress, in continuum mechanics, may be considered a measure of the internal forces acting within a volume. Such stress may be defined as a measure of the average force per unit area at a surface within the volume on which internal forces act. The internal forces are oftentimes produced between the particles in the volume as a reaction to external forces applied on the volume.

Understanding the origin and evolution of faults and the tectonic history of faulted regions can be accomplished by relating fault orientation, slip direction, geologic and geodetic data to the state of stress in the Earth's crust. In conventional inverse problems, the directions of the remote principal stresses and a ratio of their magnitudes are constrained by analyzing field data on fault orientations and slip directions as inferred from artifacts such as striations on exposed fault surfaces.

Conventional methods for stress inversion, using measured striations and/or throw on faults, are mainly based on the assumptions that the stress field is uniform within the rock mass embedding the faults (assuming no perturbed stress field), and that the slip on faults have the same direction and sense as the resolved far field stress on the fault plane. However, it has been shown that slip directions are affected by: anisotropy in fault compliance caused by irregular tip-line geometry; anisotropy in fault friction (surface corrugations); heterogeneity in host rock stiffness; and perturbation of the local stress field mainly due to mechanical interactions of adjacent faults. Mechanical interactions due to complex faults geometry in heterogeneous media can be taken into account while doing the stress inversion. By doing so, determining the parameters of such paleostress (and fluid pressure inside fault surfaces) in the presence of multiple interacting faults is determined by running numerous simulations, which takes an enormous amount of computation time to fit the observed data. The conventional parameters space has to be scanned for each possibility, and for each simulation, the model and the post-processes are recomputed.

Motion equations are oftentimes not invoked while using conventional methods, and perturbations of the local stress field by fault slip are ignored. The mechanical role played by the faults in tectonic deformation is not explicitly included in such analyses. Still, a relatively full mechanical treatment is applied for conventional paleostress inversion. However, the results may be greatly improved if multiple types of data could be used to better constrain the inversion.

### SUMMARY

Systems and methods for predicting a stress attribute of a subsurface earth volume are disclosed. One or more linearly independent far field stress models and one or more discontinuity pressure models may be simulated for the subsurface earth volume to generate stress values, strain values, displacement values, or a combination thereof for data points in the subsurface earth volume. A processor may be used to compute a superposition of the one or more linearly independent far field stress models and the one or more discontinuity pressure models. The stress attribute of the subsurface earth volume may be predicted, based on the computed stress values, strain values, displacement values, or the combination thereof.

It will be appreciated that the foregoing summary is merely intended to introduce a subset of the subject matter discussed below and is, therefore, not limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 depicts a diagram of an illustrative stress and fracture modeling system, according to one or more embodiments disclosed.

FIG. 2 depicts a block diagram of an illustrative computing environment for performing stress and fracture modeling using the principle of superposition, according to one or more embodiments disclosed.

FIG. 3 depicts a block diagram of an illustrative stress and fracture modeling engine, according to one or more embodiments disclosed.

FIGS. 4A-4C depict block diagrams comparing techniques for recovering paleostress, according to one or more embodiments disclosed. More particularly, FIG. 4A depicts a technique that uses slip distributions on faults as data input, but provides unstable results. FIG. 4B depicts a (2D) Monte Carlo method, but without the optimization using the principle of superposition. FIG. 4C depicts the method described herein, including techniques that utilize the principle of superposition and drastically reduce the complexity of the model.

FIGS. 5A-5E depict diagrams of an illustrative method applied to fracture and conjugate fault planes using data sets without magnitude information, according to one or more embodiments disclosed. More particularly, FIG. 5A shows an orientation of \vec{π} relative to an opening fracture (joints, veins, dikes) given by its normal \vec{n} in 3D. FIG. 5B shows the same as FIG. 5A, except for an orientation of σ₃ relative to a joint given by its projected normal \vec{n} (e.g., trace on outcrop). FIG. 5C and FIG. 5D show the same as FIG. 5A and FIG. 5B, except shown for a stylolite. FIG. 5E shows orientation of σ₂ and σ₁ relative to conjugate fault-planes given by one of the normal \vec{n} in 3D and the internal friction angle θ.

FIGS. 6A and 6B depict diagrams comparing illustrative stress inversion for normal fault and thrust fault configurations, according to one or more embodiments disclosed. More particularly, the inclination of the two conjugate fault planes is presented for a normal fault configuration (FIG. 6A) and a thrust fault configuration (FIG. 6B).

FIGS. 7A and 7B depict diagrams of cost functions for the stress inversions of FIG. 6, according to one or more embodiments disclosed. More particularly, FIG. 7A shows the cost function for the normal fault, and FIG. 7B shows the cost function for the thrust fault.

FIG. 8 depicts a diagram of an illustrative model configuration showing InSAR data points and a fault surface, according to one or more embodiments disclosed.

FIG. 9 depicts a diagram comparing fringes from an original InSAR grid and an InSAR grid recovered by an example stress and fracture modeling method using the principle of superposition, according to one or more embodiments disclosed.

FIG. 10 depicts a diagram showing a top view and a front perspective view of a plot of the cost surface for an example method applied to the InSAR case of FIGS. 8 and 9, with cost solution indicated, according to one or more embodiments disclosed.

FIGS. 11A-11D depict diagrams showing results of an illustrative method applied to a flattened horizon scenario, according to one or more embodiments disclosed. More particularly, FIG. 11A presents a model configuration showing the horizon and the fault surface. FIG. 11B shows a comparison of the original dip-slip (left) and the recovered dip-slip (right). FIG. 11C shows a comparison of the original strike-slip (left) and the recovered strike-slip (right). FIG. 11D shows original vertical displacement (left) from the flattened horizon (left) and recovered vertical displacement (right) from the flattened horizon.

FIG. 12 depicts a flow diagram of an illustrative method of stress and fracture modeling using the principle of superposition, according to one or more embodiments disclosed.

FIG. 13 depicts a flow diagram of an illustrative method of stress and fracture modeling using the principle of superposition and a cost function, according to one or more embodiments disclosed.

FIG. 14 depicts a model showing dykes orientations from inversion of the pressure inside a vertical plug, according to one or more embodiments disclosed.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

This disclosure describes stress and fracture modeling using the principle of superposition. Given diverse input data, such as faults geometry, and selectable or optional data sets or data measures, including fault throw, dip-slip or slickline directions, stress measurements, fracture data, secondary fault plane orientations, global positioning system (GPS) data, interferometric synthetic aperture radar (InSAR) data, geodetic data from surface tilt-meters, laser ranging, etc., the systems and methods described herein can quickly generate and/or recover numerous types of results. The systems and methods described herein apply the principle of superposition to fault surfaces with complex geometry in 2D and/or 3D, and the faults are, by nature, of finite dimension and not infinite or semi-infinite. The results are often rendered in real-time and may include, for example, real-time stress, strain, and/or displacement parameters in response to a user query or an updated parameter; remote stress states for multiple tectonic events; prediction of intended future fracturing; differentiation of preexisting fractures from induced fractures; and so forth. The diverse input data can be derived from wellbore data, seismic interpretation, field observation, etc.

The systems and methods described below are applicable to many different reservoir and subsurface operations, including exploration and production operations for natural gas and other hydrocarbons, storage of natural gas, hydraulic fracturing and matrix stimulation to increase reservoir production, water resource management including development and environmental protection of aquifers and other water resources, capture and underground storage of carbon dioxide (CO₂), and so forth.

The system can apply a 3-dimensional (3D) boundary element technique using the principle of superposition that applies to linear elasticity for heterogeneous, isotropic whole- or half-space media. Based on precomputed values, the system can assess a cost function to generate real-time results, such as stress, strain, and displacement parameters for any point in a subsurface volume as the user varies the far field stress value and the fault pressure. In one implementation, the system uses fault geometry and wellbore data, including, e.g., fracture orientation, secondary fault plane data, and/or in-situ stress measurement by hydraulic fracture, to recover one or more tectonic events and fault pressures, or one or more stress tensors represented by a ratio of principal magnitudes and the associated orientation and fault pressures. The system can use many different types of geologic data from seismic interpretation, wellbore readings, and field observation to provide a variety of results, such as predicted fracture propagation based on perturbed stress field.

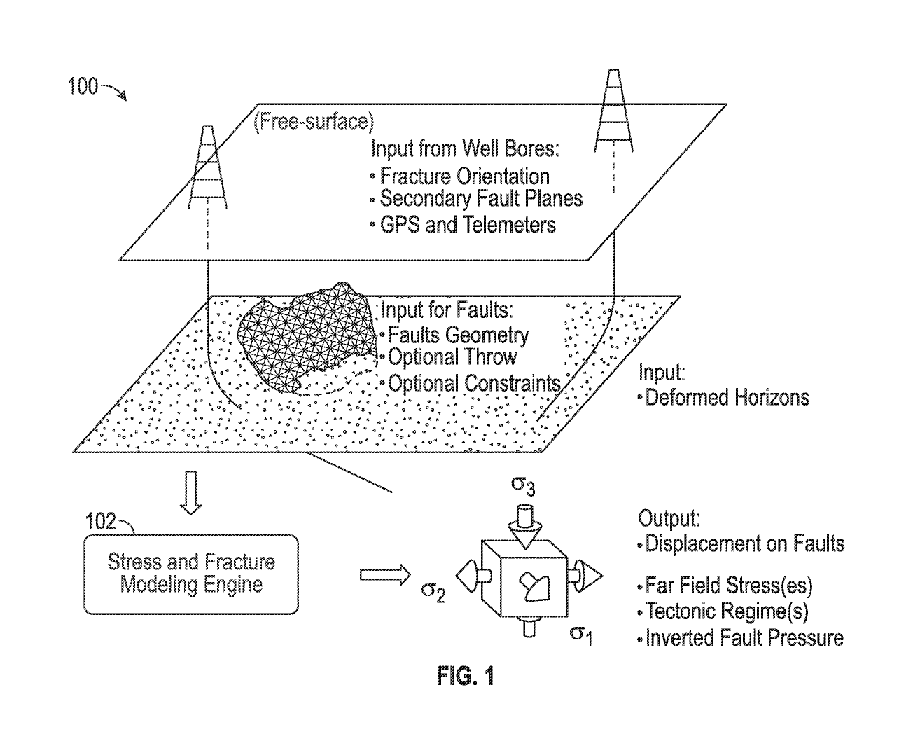

FIG. 1 shows an illustrative stress and fracture modeling system 100, according to one or more embodiments disclosed. The faults geometry is often known (and optionally, measured fault throw and imposed inequality constraints such as normal, thrust, etc., may be known). The user may have access to data from wellbores (e.g., fracture orientation, in-situ stress measurements, secondary fault planes), geodetic data (e.g., InSAR, GPS, and tilt-meter), as well as interpreted horizons. A stress and fracture modeling engine 102 can recover the remote stress state and tectonic regime for relevant tectonic events and fault pressure, as well as displacement discontinuity on faults, and estimate the displacement and perturbed strain and stress fields anywhere within the system.

Using the principle of superposition, the stress and fracture modeling system 100 or engine 102 may perform each of three linearly independent simulations of stress tensor models and one fault pressure model in constant time regardless of the complexity of each underlying model. Each model does not have to be recomputed. Then, as introduced above, applications for the system 100 may include stress interpolation and fracture modeling, recovery of tectonic events, quality control on interpreted faults, real-time computation of perturbed stress and displacement fields when the user is performing parameters estimation, prediction of fracture propagation, distinguishing preexisting fractures from induced fractures, and numerous other applications.

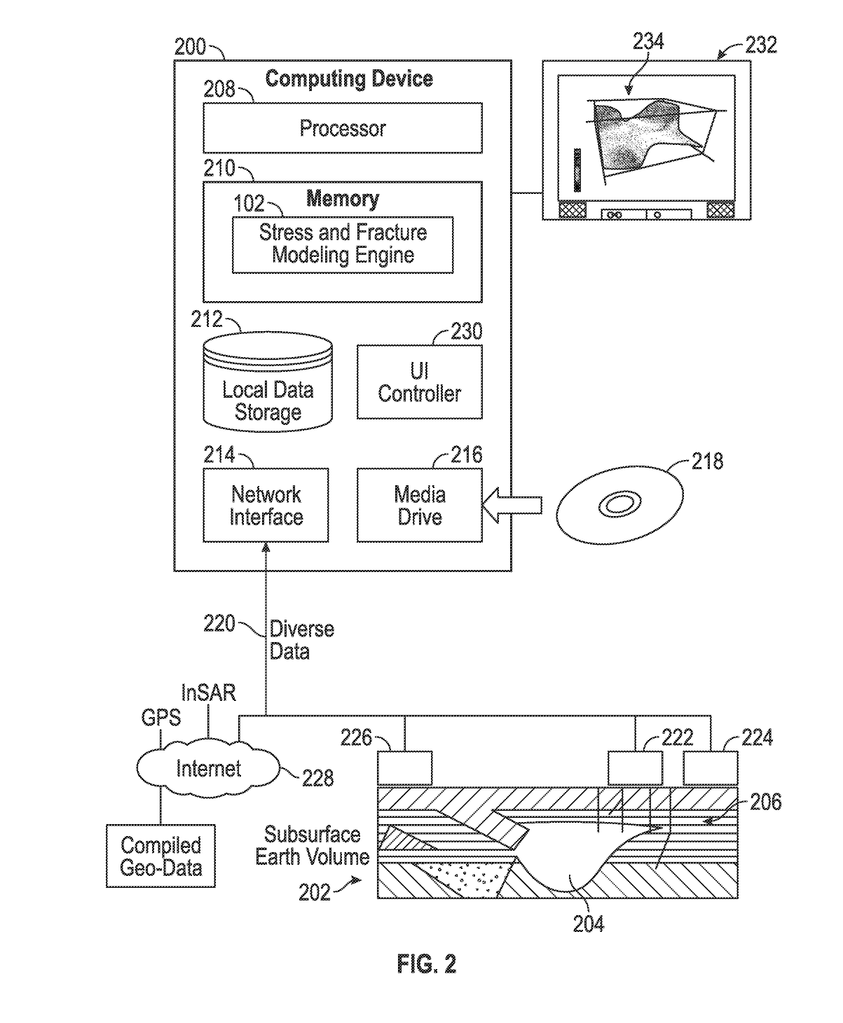

FIG. 2 shows the system 100 of FIG. 1 in the context of a computing environment, in which stress and fracture modeling using the principle of superposition can be performed, according to one or more embodiments disclosed.

A computing device 200 implements a component, such as the stress and fracture modeling engine 102. The stress and fracture modeling engine 102 is illustrated as software, but can be implemented as hardware or as a combination of hardware and software instructions.

The computing device 200 may be communicatively coupled via sensory devices (and control devices) with a real-world setting, for example, an actual subsurface earth volume 202, reservoir 204, depositional basin, seabed, etc., and associated wells 206 for producing a petroleum resource, for water resource management, or for carbon services, and so forth.

The computing device 200 may be a computer, computer network, or other device that has a processor 208, memory 210, data storage 212, and other associated hardware such as a network interface 214 and a media drive 216 for reading and writing a removable storage medium 218. The removable storage medium 218 may be, for example, a compact disk (CD); digital versatile disk/digital video disk (DVD); flash drive, etc. The removable storage medium 218 contains instructions, which when executed by the computing device 200, cause the computing device 200 to perform one or more methods described herein. Thus, the removable storage medium 218 may include instructions for implementing and executing the stress and fracture modeling engine 102. At least some parts of the stress and fracture modeling engine 102 can be stored as instructions on a given instance of the removable storage medium 218, removable device, or in local data storage 212, to be loaded into memory 210 for execution by the processor 208.

Although the stress and fracture modeling engine 102 is depicted as a program residing in memory 210, in other embodiments, the stress and fracture modeling engine 102 may be implemented as hardware, such as an application specific integrated circuit (ASIC) or as a combination of hardware and software.

The computing device 200 may receive incoming data 220, such as faults geometry and many other kinds of data, from multiple sources, such as wellbore measurements 222, field observation 224, and seismic interpretation 226. The computing device 200 can receive many types of data sets 220 via the network interface 214, which may also receive data from the Internet 228, such as GPS data and InSAR data.

The computing device 200 may compute and compile modeling results, simulator results, and control results, and a display controller 230 may output geological model images and simulation images and data to a display 232. The images may be a 2D or 3D simulation 234 of stress and fracture results using the principle of superposition. The stress and fracture modeling engine 102 may also generate one or more visual user interfaces (UIs) for input and display of data.

The stress and fracture modeling engine 102 may also generate and/or produce control signals to be used via control devices, e.g., such as drilling and exploration equipment, or well control injectors and valves, in real-world control of the reservoir 204, transport and delivery network, surface facility, and so forth.

Thus, the system 100 may include a computing device 200 and an interactive graphics display unit 232. The system 100 as a whole may constitute simulators, models, and the example stress and fracture modeling engine 102.

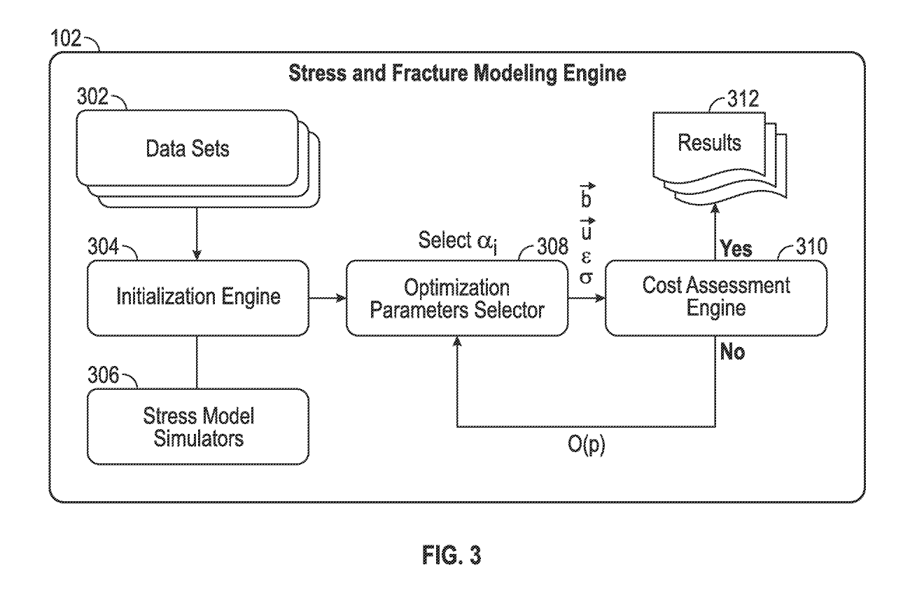

FIG. 3 shows the stress and fracture modeling engine 102 in greater detail, according to one or more embodiments disclosed. The stress and fracture modeling engine 102 illustrated in FIG. 3 includes a buffer for data sets 302 or access to the data sets 302, an initialization engine 304, stress model simulators 306 or an access to the stress model simulators 306, a optimization parameters selector 308, a cost assessment engine 310, and a buffer or output for results 312. Other components, or other arrangements of the components, may also be used to enable various implementations of the stress and fracture modeling engine 102. The functionality of the stress and fracture modeling engine 102 will be described next.

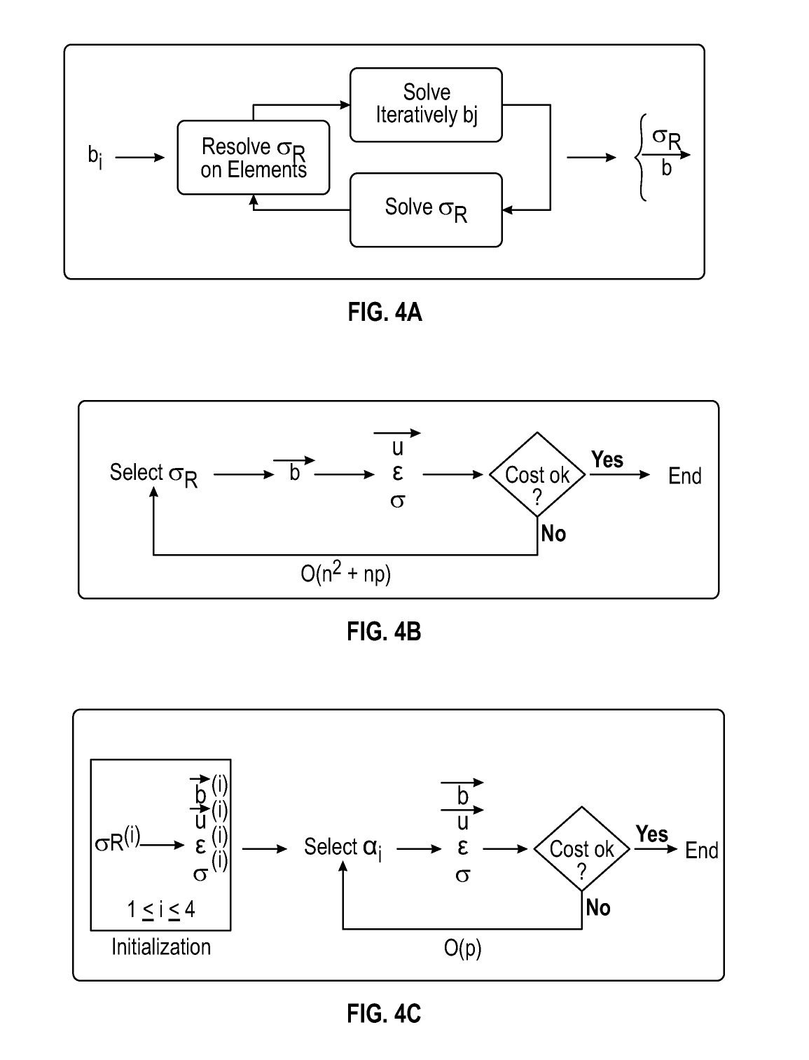

FIG. 4 shows various methods for recovering paleostress, according to one or more embodiments disclosed. FIG. 4A shows a technique that uses slip distributions on faults as data input, but provides unstable results. The technique of FIG. 4A may not augment the slip distributions with other forms of data input, such as GPS data, and so forth. FIG. 4B shows a (2D) Monte Carlo method, but without the optimization using the principle of superposition. FIG. 4C shows the method described herein, including techniques that utilize the principle of superposition and drastically reduce the complexity of the model. The method shown in FIG. 4C may be implemented by the stress and fracture modeling engine 102. For example, in one implementation the initialization engine 304, through the stress model simulators 306, generates three precomputed models of the far field stress associated with a subsurface volume 202. For each of the three models, the initialization engine 304 precomputes, for example, displacement, strain, and/or stress values. The optimization parameters selector 308 iteratively scales the displacement, strain, and/or stress values for each superpositioned model to minimize a cost at the cost assessment engine 310. The values thus optimized in real-time are used to generate particular results 312.

In one implementation, the three linearly independent far field stress parameters are: (i) orientation toward the North, and (ii) & (iii) the two principal magnitudes. These far field stress parameters are modeled and simulated to generate a set of the variables for each of the three simulated models. Four variables can be used: displacement on a fault, the displacement field at any data point or observation point, a strain tensor at each observation point, and the tectonic stress. The optimization parameters selector 308 selects an alpha for each simulation, i.e., a set of “alphas” for the four simulated stress models to act as changeable optimization parameters for iteratively converging on values for these variables in order to minimize one or more cost functions, to be described below. In one implementation, the optimization parameters selector 308 selects optimization parameters at random to begin converging the scaled strain, stress, and or displacement parameters to lowest cost. When the scaled (substantially optimized) parameters are assessed to have the lowest cost, the scaled strain, stress, and/or displacement parameters can be applied to predict a result, such as a new tectonic stress.

Because the method of FIG. 4C uses precomputed values superpositioned from their respective simulations, the stress and fracture modeling engine 102 can provide results quickly, even in real-time. As introduced above, the stress and fracture modeling engine 102 can quickly recover multiple tectonic events responsible for present conditions of the subsurface volume 202, more quickly discern induced fracturing from preexisting fracturing than conventional techniques, provide real-time parameter estimation as the user varies a stress parameter, and/or rapidly predict fracturing.

While conventional paleostress inversion may apply a full mechanical scenario, the stress and fracture modeling engine 102 improves upon conventional techniques by using multiple types of data. Data sets 302 to be used are generally of two types: those which provide orientation information (such as fractures, secondary fault planes with internal friction angle, and fault striations, etc.), and those which provide magnitude information (such as fault slip, GPS data, InSAR data, etc.). Conventionally, paleostress inversion has been computed using slip measurements on fault planes.

The technique shown in FIG. 4A executes an operation that proceeds in two stages: (i) resolving the initial remote stress tensor σ_{R} onto the fault elements that have no relative displacement data and solving for the unknown relative displacements (bⱼ in FIG. 4A); and, (ii) using the computed and known relative displacements to solve for σ_{R} (FIG. 4A). An iterative solver is used that cycles between stages (i) and (ii) until convergence.

The technique shown in FIG. 4B is based on a Monte-Carlo algorithm. However, this technique proves to be unfeasible since computation time is lengthy, for which the complexity is O(n²+p), where n and p are a number of triangular elements modeling the faults and the number of data points, respectively. For a given simulation, a random far field stress σ_{R} is chosen, and the corresponding displacement discontinuity \vec{μ} on faults is computed. Then, as a post-process at data points, and depending on the type of measurements, cost functions are computed using either the displacement, strain, or stress field. In this scenario, for hundreds of thousands of simulations, the best cost (close to zero) is retained as a solution.

On the other hand, the method diagrammed in FIG. 4A, which can be executed by the stress and fracture modeling engine 102, extends inversion for numerous kinds of data, and provides a much faster modeling engine 102. For example, a resulting fast and reliable stress inversion is described below. The different types of data can be weighted and combined together. The stress and fracture modeling engine 102 can quickly recover the tectonic events and fault pressure as well as displacement discontinuity on faults using diverse data sets and sources, and then obtain an estimate of the displacement and perturbed strain and stress field anywhere within the medium, using data available from seismic interpretation, wellbores, and field observations. Applying the principle of superposition allows a user to execute parameters estimation in a very fast manner.

A numerical technique for performing the methods is described next. Then, a reduced remote tensor used for simulation is described, and then the principle of superposition itself is described. An estimate of the complexity is also described.

In one implementation, a formulation applied by the stress and fracture modeling engine 102 can be executed using IBEM3D, a successor of POLY3D. POLY3D is described by F. Maerten, P. G. Resor, D. D. Pollard, and L. Maerten, Inverting for slip on three-dimensional fault surfaces using angular dislocations, Bulletin of the Seismological Society of America, 95:1654-1665, 2005, and by A. L. Thomas, Poly3D: a three-dimensional, polygonal element, displacement discontinuity boundary element computer program with applications to fractures, faults, and cavities in the earth's crust, Master's thesis, Stanford University, 1995. IBEM3D is a boundary element code based on the analytical solution of an angular dislocation in a homogeneous or inhomogeneous elastic whole- or half-space. An iterative solver can be employed for speed considerations and for parallelization on multi-core architectures. (See, for example, F. Maerten, L. Maerten, and M. Cooke, Solving 3d boundary element problems using constrained iterative approach, Computational Geosciences, 2009.) However, inequality constraints may not be used as they are nonlinear and the principle of superposition does not apply. In the selected code, faults are represented by triangulated surfaces with discontinuous displacement. The three-dimensional fault surfaces can more closely approximate curvi-planar surfaces and curved tip-lines without introducing overlaps or gaps.

Mixed boundary conditions may be prescribed, and when traction boundary conditions are specified, the initialization engine 304 solves for unknown Burgers's components. After the system is solved, it is possible to compute anywhere, within the whole- or half-space, displacement, strain, or stress at observation points, as a post-process. Specifically, the stress field at any observation point is given by the perturbed stress field due to slipping faults plus the contribution of the remote stress. Consequently, obtaining the perturbed stress field due to the slip on faults is not enough. Moreover, the estimation of fault slip from seismic interpretation is given along the dip-direction. Nothing is known along the strike-direction, and a full mechanical scenario is used to recover the unknown components of the slip vector as it will impact the perturbed stress field. Changing the imposed far field stress (orientation and or relative magnitudes) modifies the slip distribution and consequently the perturbed stress field. In general, a code such as IBEM3D is well suited for computing the full displacement vectors on faults, and has been intensively optimized using an H-matrix technique. The unknown for purposes of modeling remains the estimation of the far field stress that has to be imposed as boundary conditions.

In one embodiment, which may be implemented by the stress and fracture modeling engine 102, a model composed of multiple fault surfaces is subjected to a constant far field stress tensor σ_{R} defined in the global coordinate system by Equation (1):

$${σ}_{R} = [ \begin{matrix}{a}_{11} & {a}_{12} & {a}_{13} \\ & {a}_{22} & {a}_{23} \\ & & {a}_{33}\end{matrix} ] \qquad ( 1 )$$

Assuming a sub-horizontal far field stress (but the present methodology is not restricted to that case), Equation (1) simplifies into Equation (2):

$${σ}_{R} = [ \begin{matrix}{a}_{11} & {a}_{12} & 0 \\ & {a}_{22} & 0 \\ & & {a}_{33}\end{matrix} ] \qquad ( 2 )$$

Since the addition of a hydrostatic stress does not change σ_{R}, the far field stress tensor σ_{R} can be written as in Equation (3):

$${σ}_{R} = [ \begin{matrix}{a}_{11} - {a}_{33} & {a}_{12} & 0 \\ & {a}_{22} - {a}_{33} & 0 \\ & & 0\end{matrix} ] = [ \begin{matrix}{\overline{a}}_{11} & {a}_{12} \\ & {\overline{a}}_{22}\end{matrix} ] \qquad ( 3 )$$

Consequently, a definition of a far field stress with three unknowns is obtained, namely {ā₁₁, ā₂₂, ā₁₂}.

The far field stress tensor, as defined in Equation (3) can be computed using two parameters instead of the three {ā₁₁, ā₂₂, ā₁₂}. Using spectral decomposition of the reduced σ_{R}, Equation (4) may be obtained:

σ_{R}=σ_{θ}^{T}σR_{θ} (4)

where, as in Equation (5):

$${σ}_{R} = [ \begin{matrix}{σ}_{1} & 0 \\ & {σ}_{2}\end{matrix} ] \qquad ( 5 )$$

the far field stress tensor σ_{R} is the matrix of principal values, and in Equation (6):

$${R}_{θ} = [ \begin{matrix}cos θ & - sin θ \\ sin θ & cos θ\end{matrix} ] \qquad ( 6 )$$

is the rotation matrix around the global z-axis (since a sub-horizontal stress tensor is assumed).

By writing, in Equation (7):

σ₂=kσ₁ (7)

Equation (4) then transforms into Equation (8):

$${σ}_{R} ( θ , k ) = {σ}_{1} {R}_{θ}^{T} [ \begin{matrix}1 & 0 \\ 0 & k\end{matrix} ] {R}_{θ} \qquad ( 8 )$$

Omitting the scaling parameter σ₁ due to Property 1 discussed below (when σ₁=δ in

Property 1), σ_{R} can be expressed as a functional of two parameters δ and k, as in Equation (9):

$${σ}_{R} ( θ , k ) = {R}_{θ}^{T} [ \begin{matrix}1 & 0 \\ 0 & k\end{matrix} ] {R}_{θ} \qquad ( 9 )$$

These two parameters are naturally bounded by Equations (10):

$$\{ \begin{matrix}- π / 2 \leq θ \leq π / 2 \\ - 10 \leq k \leq 10\end{matrix} \qquad ( 10 )$$

assuming that uniaxial remote stress starts to occur when k≧10. For k=1, a hydrostatic stress tensor is found, which has no effect on the model. Also, using a lithostatic far field stress tensor (which is therefore a function of depth z) does not invalidate the presented technique, and Equation (9) transforms into Equation (11):

$${σ}_{R} ( θ , k , z ) = z {R}_{θ}^{T} [ \begin{matrix}1 & 0 \\ 0 & k\end{matrix} ] {R}_{θ} \qquad ( 11 )$$

which is linearly dependent on z. The simplified tensor definition given by Equation (9) is used in the coming sections to determine θ, k), or equivalently {ā₁₁, ā₂₂, ā₁₂} according to measurements.

Even when 3-dimensional parameter-space is used for the Monte-Carlo simulation using (θ, k, p), where p is the fault pressure, three components are still used for the far field stress, specified by the parameters (α₁, α₂, α₃, α₄). The conversions are given by Expression (12):

(θ, k)→(σ₀₀, σ₀₁, σ₁₁)→(α₁, α₂, α₃) (12)

where, in Equations (13):

$$\{ \begin{matrix}{σ}_{00} = {cos}^{2} θ + k {sin}^{2} θ \\ {σ}_{01} = ( k - 1 ) cos θsinθ \\ {σ}_{11} = {cos}^{2} θ + k {sin}^{2} θ\end{matrix} \qquad ( 13 )$$

and (α₁, α₂, α₃) are given by Equation (20), further below.

Principle of Superposition

The stress and fracture modeling engine 102 uses the principle of superposition, a well-known principle in the physics of linear elasticity, to recover the displacement, strain, and stress at any observation point P using the precomputed specific values from linearly independent simulations. The principle of superposition stipulates that a given value f can be determined by a linear combination of specific solutions.

In the stress and fracture modeling engine 102, recovering a far field stress implies recovering the three parameters (α₁, α₂, α₃). Therefore, the number of linearly independent solutions used is three. In other words, in Equation (14):

$$\begin{matrix}f = F ( σ ) \\ = F ( {α}_{1} {σ}^{( 1 )} + {α}_{2} {σ}^{( 2 )} + {α}_{3} {σ}^{( 3 )} ) \\ = {α}_{1} F ( {σ}^{( 1 )} ) + {α}_{2} F ( {σ}^{( 2 )} ) + {α}_{3} F ( {σ}^{( 3 )} ) \\ = {α}_{1} {f}_{1} + {α}_{2} {f}_{2} + {α}_{3} {f}_{3}\end{matrix} \qquad ( 14 )$$

where (α₁, α₂, α₃) are real numbers, and σ⁽ⁱ⁾ (for i=1 to 3) are three linearly independent remote stress tensors. If F is selected to be the strain, stress or displacement Green's functions, then the resulting values ε, σ, and u, at P can be expressed as a combination of three specific solutions, as shown below. Thus, the strain, stress and displacement field for a tectonic loading are a linear combination of the three specific solutions, and are given by Equation (15):

$$\{ \begin{matrix}{ε}_{P} = {α}_{1} {ɛ}_{P}^{( 1 )} + {α}_{2} {ɛ}_{P}^{( 2 )} + {α}_{3} {ɛ}_{P}^{( 3 )} \\ {σ}_{P} = {α}_{1} {σ}_{P}^{( 1 )} + {α}_{2} {σ}_{P}^{( 2 )} + {α}_{3} {σ}_{P}^{( 3 )} \\ {u}_{P} = {α}_{1} {u}_{P}^{( 1 )} + {α}_{2} {u}_{P}^{( 2 )} + {α}_{3} {u}_{P}^{( 3 )}\end{matrix} \qquad ( 15 )$$

Similarly, using (α₁, α₂, α₃) allows recovery of the displacement discontinuities on the faults, as in Equation (16):

bₑ=α₁bₑ⁽¹⁾+α₂bₑ⁽²⁾+α₃bₑ⁽³⁾ (16)

and any far field stress is also given as a combination of the three parameters, as in Equation (17):

σ_{R}=α₁σ_{R}⁽¹⁾+α₂σ_{R}⁽²⁾+α₃σ_{R}⁽³⁾ (3)

Complexity Estimate

The entire model is oftentimes recomputed to change σ_{R} to determine the corresponding unknown displacement discontinuities. Then, at any observation point P, the stress is determined as a superimposition of the far field stress σ_{R} and the perturbed stress field due to slipping elements.

For a model made of n triangular discontinuous elements, computing the stress state at point P first involves solving for the unknown displacement discontinuities on triangular elements (for which the complexity is 0(n²), and then performing approximately 350n multiplications using the standard method. By using the principle of superposition, on the other hand, the unknown displacement discontinuities on triangular elements do not have to be recomputed, and many fewer (e.g., 18) multiplications are performed by the stress and fracture modeling engine 102. The complexity is independent of the number of triangular elements within the model, and is constant in time.

Some direct applications of the methods will now be described, such as real-time evaluation of deformation and the perturbed stress field while a user varies a far field stress parameter. Paleostress estimation using different data sets 302 is also presented further below, as is a method to recover multiple tectonic phases, and a description of how the example method can be used for quality control during fault interpretation.

Real-Time Computation

Before describing the paleostress inversion method, another method is described first, for real-time computing displacement discontinuity on faults, and the displacement, strain, and stress fields at observation points while the orientation and/or magnitude of the far field stress is varied.

If the tectonic stress σ_{R} is given and three independent solutions are known, there exists a unique triple (α₁, α₂, α₃) for which Equation (17) is honored, and Equations (15) and (16) can be applied.

In matrix form, Equation (17) is written in the format shown in Equation (18):

$$[ \begin{matrix}{σ}_{00}^{( 1 )} & {σ}_{00}^{( 2 )} & {σ}_{00}^{( 3 )} \\ {σ}_{01}^{( 1 )} & {σ}_{01}^{( 2 )} & {σ}_{01}^{( 3 )} \\ {σ}_{11}^{( 1 )} & {σ}_{11}^{( 2 )} & {σ}_{11}^{( 3 )}\end{matrix} ] \{ \begin{matrix}{α}_{1} \\ {α}_{2} \\ {α}_{3}\end{matrix} \} = \{ \begin{matrix}{σ}_{00}^{R} \\ {σ}_{01}^{R} \\ {σ}_{11}^{R}\end{matrix} \} \qquad ( 18 )$$

or, in compact form, as in Equation (19):

A_{σ}α=σ_{R} (19)

Since the three particular solutions u are linearly independent, the system can be inverted, which gives Equation (20):

α=A_{σ}⁻¹σ_{R} (20)

In Equation (20), A_{σ}⁻¹ is precomputed by the initialization engine 304. Given a user-selected remote stress, σ_{R}, the stress and fracture modeling engine 102 recovers the three parameters (α₁, α₂, α₃), then the fault slip and the displacement, strain and stress field are computed in real-time using Equations (16) and (15), respectively. To do so, the three particular solutions of the displacement, strain and stress are stored at initialization at each observation point, as well as the displacement discontinuity on the faults. In one implementation, the example stress and fracture modeling engine 102 enables the user to vary the orientation and magnitude of σ_{R}, and to interactively display the associated deformation and perturbed stress field.

Paleostress Inversion Using Data Sets

As seen above, the main unknowns while doing forward modeling for the estimation of the slip distribution on faults, and consequently the associated perturbed stress field, are the orientation and relative magnitudes of the far field stress σ_{R}.

If field measurements are known at some given observation points (e.g., displacement, strain and/or stress, fractures orientation, secondary fault planes that formed in the vicinity of major faults, etc.), then it is possible to recover the triple (α₁, α₂, α₃), and therefore also recover the tectonic stress σ_{R} and the corresponding tectonic regime. The next section describes the method of resolution and the cost functions used to minimize cost for different types of data sets 302.

Method of Resolution

Applying a Monte Carlo technique allows the parameters (α₁, α₂, α₃) to be found, which minimize the cost functions when given three independent far field stresses (see Equation 15). However, even if (α₁, α₂, α₃) imply a 3-dimensional parameters-space, this space can be reduced to two dimensions (namely, to the parameters θ and k), the conversion being given by Equation (20) and (θ,k). →(σ₀₀, σ₀₁, σ₁₁)→(α₁, α₂, α₃), where, in Equations (21):

$$\{ \begin{matrix}{σ}_{00} = {cos}^{2} θ + k {sin}^{2} θ \\ {σ}_{01} = ( k - 1 ) cos θ sin θ \\ {σ}_{11} = {cos}^{2} θ + k {sin}^{2} θ\end{matrix} \qquad ( 21 )$$

(see also FIG. 4C and Algorithm 1 for a detailed description). Consequently, the searching method (e.g., the search for optimized parameters) is accelerated by reducing the parameters-space by one dimension.

A simple sampling method can be performed by considering a two-dimensional rectangular domain for which the axes correspond to θ and k. The 2D-domain is sampled randomly with nₚ points, and the associated cost function (to be defined in the coming sections) is used to determine the point of minimum cost. A refinement is then created around the selected point and the procedure is repeated with a smaller domain. Algorithm (1) depicts a simplified version of the procedure, for which there is no refinement. The example sampling method presented here can be greatly optimized by various techniques.

ALGORITHM (1): Paleostress Estimation

```
Input: Faults geometry
Input: Data set
Output: σ_{R} // the estimated paleostress
Initialize: Compute 3 simulations using 3 linearly independent
σ_{R}⁽ⁱ⁾ (1 ≦ i ≦ 3) and the faults geometry. Store the resulting displacement
and stress fields at data points, and the displacement discontinuity at faults,
if necessary.
Let c = 1 // initial cost
Let α = (0,0,0,) // initial (α) solution
for i = 1 to nₚ do
    $Randomly generate θ ∈ [ - \frac{π}{2} , \frac{π}{2} ]$
    Randomly generate k ∈ [−10,10]
    // Convert (θ, k) ∈ [symbol]  ² to (α) ∈ [symbol]  ³
    Compute R_{θ} using Equation (6)
    Compute σ_{R} (θ, k) using Equation (9)
    Compute α using Equation (20)
    // Compute the corresponding cost
    d = cost(α, data set)
    if d ≦ c then
      α̅ = α
      c = d
    end
end
${σ}_{R} = {\sum }_{i = 1}^{3} {\overline{α}}_{i} {σ}_{R}^{i}$
```

### A Second Formulation of the Monte-Carlo 2D Domain

Other formulations of the Monte-Carlo 2D Domain may be used without departing from the scope of the claims. For example, below is another formulation that may be used.

In the formulation below, 0 is defined as a value between 0 and π, rather than between −π/2 and π/2. Further, θ=0 corresponds to the north and the angle is defined clockwise.

Equation (2) above may be changed to the following Equation (2′):

$${σ}_{R} = {R}_{θ , ϕ , Ψ} [ \begin{matrix}{σ}_{h} & & \\ & {σ}_{H} & \\ & & {σ}_{v}\end{matrix} ] {R}_{θ , ϕ , Ψ}^{T} \qquad ( {2}^{′} )$$

Equation (3) above may be changed to the following Equation (3′), where R_{θ} is the rotation matrix along the vertical axis (clockwise) with θ∈[0,π],:

$${σ}_{R} = {R}_{θ} [ \begin{matrix}{σ}_{h} - {σ}_{v} & \\ & {σ}_{H} - {σ}_{v}\end{matrix} ] {R}_{θ}^{T} \qquad ( {3}^{′} )$$

Using the second formulation, the definition of a regional stress has three unknowns, namely (σₕ-σᵥ), (σ_{H}-σᵥ), and θ. Expressing (2′) using σ₁, σ₂ and σ₃ for the three Andersonian fault regimes (Anderson, 1905), factorizing with (σ₁-σ₃) and introducing the stress ratio, R=(σ₂-σ₃)/(σ₁-σ₃) ∈[0,1], the following Equation (22) results as follows:

$${σ}_{R} = \{ \begin{matrix}( {σ}_{1} - {σ}_{3} ) {R}_{θ} [ \begin{matrix}- 1 & \\ & R - 1\end{matrix} ] {R}_{θ}^{T} & for Normal fault regime \\ ( {σ}_{1} - {σ}_{3} ) {R}_{θ} [ \begin{matrix}- R & \\ & 1 - R\end{matrix} ] {R}_{θ}^{T} & for Wrench fault regime \\ ( {σ}_{1} - {σ}_{3} ) {R}_{θ} [ \begin{matrix}R & \\ & 1\end{matrix} ] {R}_{θ}^{T} & for Thrust fault regime\end{matrix} \qquad ( 22 )$$

By changing R to R′ as shown in equation (23) as follows, a unique stress shape parameter R′ is created for the three fault regimes together:

$${R}^{′} ∈ [ 1 , 3 ] = \{ \begin{matrix}R ∈ [ 0 , 1 ] & for Normal fault regime \\ 2 - R ∈ [ 1 , 2 ] & for Wrench fault regime \\ 2 + R ∈ [ 2 , 3 ] & for Thrust fault regime\end{matrix} , \qquad ( 23 )$$

Omitting the scaling factor (σ₁-σ₃), the regional stress tensor in (23) is defined with only two parameters, θ and R′. This definition may be used as shown below to determine (θ, R′) according to the data utilized.

Continuing with the second formulation, Equation (7) above is not used. Further, Equation 10 is replaced with the following equation (10′):

$$\{ \begin{matrix}0 \leq θ \leq π \\ 0 \leq {R}^{′} \leq 3\end{matrix} \qquad ( {10}^{′} )$$

Equation (12) becomes Equation (12′) as follows:

(θ, R′)→(σ₀₀, σ₀₁, σ₁₁)→(α₁, α₂, α₃) (12′)

Further, equations (13) and (21) are replaced by:

$$\{ \begin{matrix}{σ}_{00} = sin β - cos {βcos}^{2} θ \\ {σ}_{01} = cos βsin θcos θ \\ {σ}_{00} = sin β - cos {βsin}^{2} θ\end{matrix} \qquad ( {13}^{′} )$$

with β being an angle defined as

$$\{ \begin{matrix}β = {tan}^{- 1} ( \frac{{R}^{′} - 1}{{R}^{′}} ) & for normal fault regime \\ β = {tan}^{- 1} ( {R}^{′} - 1 ) & for strike - slip fault regime \\ β = {tan}^{- 1} ( \frac{1}{3 - {R}^{′}} ) & for thrust fault regime\end{matrix}$$

Further, Algorithm (1) may be changed to the following Algorithm (1′):

ALGORITHM (1'): Paleostress Estimation

```
Input: Faults geometry
Input: Data set
Output: σ_{R} // the estimated paleostress
Initialize: Compute 3 simulations using 3 linearly independent
σ_{R}⁽ⁱ⁾ (1 ≦ i ≦ 3) and the faults geometry. Store the resulting displacement
and stress fields at data points, and the displacement discontinuity at faults,
if necessary.
Let c = 1 // initial cost
Let α = (0,0,0,) // initial (α) solution
for i = 1 to nₚ do
  Randomly generate θ ε [0,π]
  Randomly generate R′ ∈ [0,3]
  // Convert (θ, R′) ∈ [symbol]   ² to α ∈ [symbol]   ³
  Compute σ_{R} (θ, R′) using equation (13')
  Compute α using equation (20)
  // Compute the corresponding cost
  d = cost (α, data set)
  if d ≦ c then
    α̅ = α
    c = d
  end
end
${σ}_{R} = {\sum }_{i = 1}^{3} {\overline{α}}_{i} {σ}_{R}^{i}$
```

While the above discussion presents a second formulation, other formulations may be used without departing from the scope of the claims.

Data Sets

The particularity of this method lies in a fact that many different kinds of data sets 302 can be used to constrain the inversion. Two groups of data are presented in the following sections: the first one includes orientation information and the second includes displacement and/or stress magnitude information.

Without Magnitude Information from the Data Set

For opening fractures (e.g., joints, veins, dikes) the orientation of the normal to the fracture plane indicates the direction of the least compressive stress direction in 3D (σ₃). Similarly, the normals to pressure solution seams and stylolites indicate the direction of the most compressive stress (σ₁). Using measurements of the orientations of fractures, pressure solution seams, and stylolites allows the stress and fracture modeling engine 102 to recover the tectonic regime which generated such features.

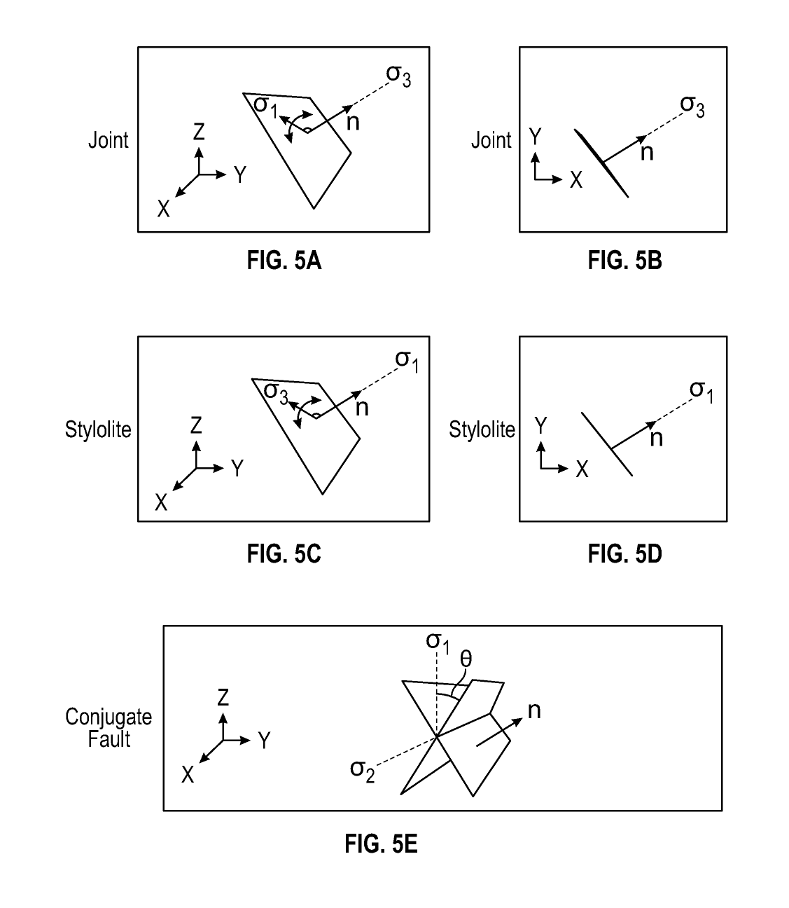

At any observation point P, the local perturbed stress field can be determined from a numerical point of view by using three linearly independent simulations. FIG. 5 shows fracture and conjugate fault planes, according to one or more embodiments disclosed. FIG. 5A shows orientation of σ₃ relative to an opening fracture (joints, veins, dikes) given by its normal \vec{n} in 3D. FIG. 5B shows the same as FIG. 5A, except for an orientation of σ₃ relative to a joint given by its projected normal \vec{n} (e.g., trace on outcrop). FIG. 5C and FIG. 5D show the same as FIG. 5A and FIG. 5B, except shown for a stylolite. FIG. 5E shows orientation of σ₂ and σ₁ relative to conjugate fault-planes given by one of the normal \vec{n} in 3D and the internal friction angle θ. The goal is to determine the best fit of the far field stress σ_{R}, and therefore parameters (α₁, α₂, α₃), given some orientations of opening fracture planes for which the normals coincide with the directions of the least compressive stress σ₃^{P} at P, or equivalently for which the plane of the fracture contains the most compressive stress (σ₁), as in FIG. 5A and FIG. 5B.

By varying (α₁, α₂, α₃), the state of stress at any observation point P can be computed quickly using the three precomputed models. The cost function to minimize is given in Equation (24):

$${f}_{frac} ( {α}_{1} , {α}_{2} , {a}_{3} ) = \frac{1}{2 m} {\sum }_{P} {( {( {\vec{σ}}_{1}^{P} \cdot {\vec{n}}^{P} )}^{2} + {( {\vec{σ}}_{2}^{P} \cdot {\vec{n}}^{P} )}^{2} )}^{1 / 2} \qquad ( 24 )$$

where “.” is the dot-product, \vec{n} is the normal to a fracture plane, and m is the number of observation points. The minimization of a function of the three parameters is expressed by Equation (25):

F_{frac}=min_{α}_{₁}_{,α}_{₂}_{,α}_{₃}{f_{frac}(α₁, α₂, α₃)}(25)

Similarly, for pressure solution seams and stylolites, the cost function is defined as in Equation (22) using the least compressive stress σ₃ as in Equation (26) (see FIG. 5C and FIG. 5D):

$${f}_{styl} ( {α}_{1} , {α}_{2} , {a}_{3} ) = \frac{1}{2 m} {\sum }_{P} {( {( {\vec{σ}}_{3}^{P} \cdot {\vec{n}}^{P} )}^{2} + {( {\vec{σ}}_{2}^{P} \cdot {\vec{n}}^{P} )}^{2} )}^{1 / 2} \qquad ( 26 )$$

Using Secondary Fault Planes

The orientation of secondary fault planes that develop in the vicinity of larger active faults may be estimated using a Coulomb failure criteria, defined by Equation (27):

tan(2θ)=1/μ (27)

where θ is the angle of the failure planes to the maximum principal compressive stress σ₁ and μ is the coefficient of internal friction. Two conjugate failure planes intersect along σ₂ and the fault orientation is influenced by the orientation of the principal stresses and the value of the friction.

The cost function is therefore defined by Equation (28):

$${f}_{fault} ( {α}_{1} , {α}_{2} , {a}_{3} ) = \frac{1}{2 m} {\sum }_{P} {[ {( {\vec{σ}}_{2}^{P} \cdot {\vec{n}}^{P} )}^{2} + {( \frac{\vert {sin}^{- 1} ( {\vec{σ}}_{1}^{P} \cdot {\vec{n}}^{P} ) \vert - θ}{π} )}^{2} ]}^{1 / 2} \qquad ( 28 )$$

where σ₁ is the direction of the most compressive stress and σ₂ is the direction of the intermediate principal stress. The first term of the right hand side in Equation (26) maintains an orthogonality between the computed σ₂ and the normal of the fault plane, whereas the second term ensures that the angle between the computed σ₁ and the fault plane is close to θ (see FIG. 5E).

Example: Normal and Thrust Fault

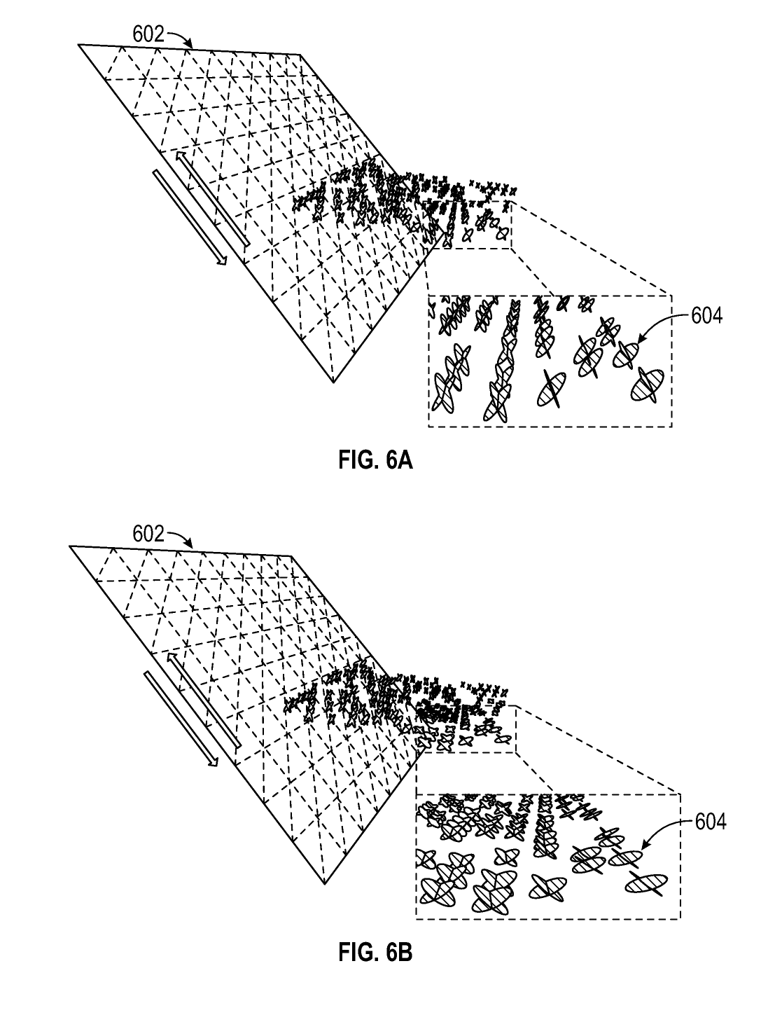

FIG. 6 shows a synthetic example using an inclined planar fault as one of two conjugate fault planes selected randomly, according to one or more embodiments disclosed. The inclination of the two conjugate fault planes is presented for a normal fault configuration (FIG. 6A) and a thrust fault configuration (FIG. 6B). Dip-azimuth and dip-angle of each conjugate fault plane are used to perform the inversion and the internal friction angle is θ=30. The main active fault is represented by the inclined rectangular plane 602.

Initially, the model is constrained by a far field stress at some observation points 604, where the two conjugate planes are computed using an internal friction angle of 30 degrees. Then, for each observation point 604, one of the conjugate fault planes is chosen randomly and used as input data for the stress inversion.

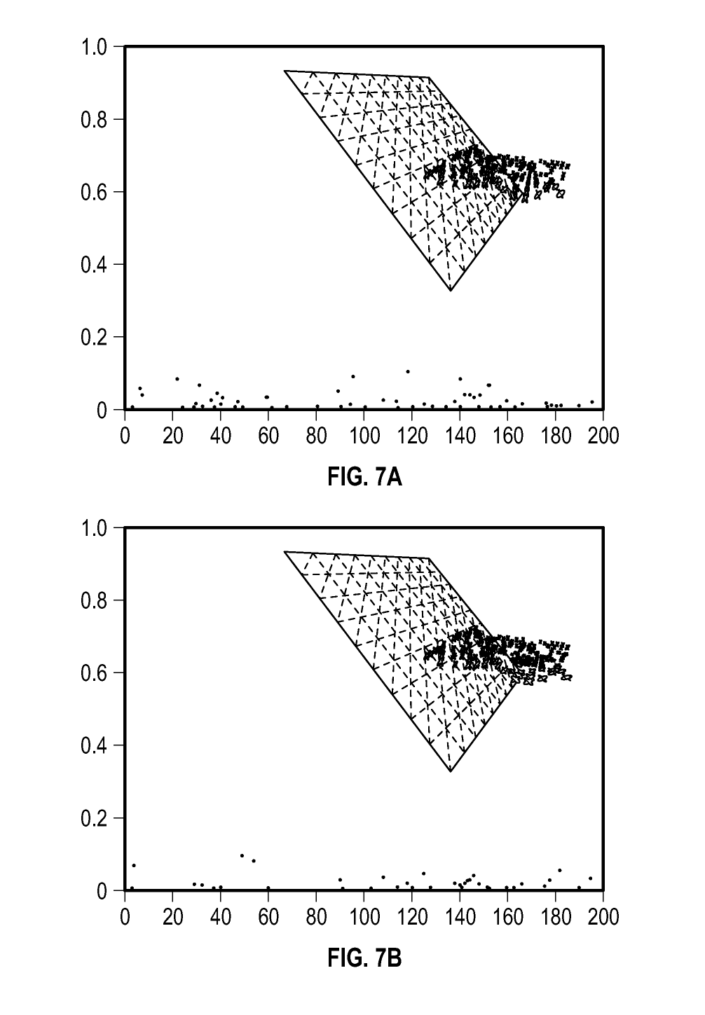

FIG. 7 shows the cost function for the synthetic example from FIG. 6, according to one or more embodiments disclosed. FIG. 7A shows the cost function for the normal fault, and FIG. 7B shows the cost function for the thrust fault. In both cases, the recovered regional stress tensor, displacement on fault, and predicted conjugate fault planes provide a good match with the initial synthetic model.

Using Fault Striations

In the case of fault striations, the cost function is defined as in Equation (29):

$${f}_{stri} ( {α}_{1} , {α}_{2} , {α}_{3} ) = \frac{1}{m} {\sum }_{P} {( 1 - {( 1 - {\vec{d}}_{e}^{c} \cdot {\vec{d}}_{e}^{m} )}^{2} )}^{1 / 2} \qquad ( 29 )$$

where \vec{d}ₑ^{c} and \vec{d}ₑ^{m} represent the normalized slip vector from a simulation and the measured slip vector, respectively.

Data Sets Containing Magnitude Information

The magnitude of displacements may be used to determine the stress orientation and the magnitude of the remote stress tensor, instead of just the principal stress ratio.

To do so, the procedure is similar to that described previously. However, given Equations (15) and (16), it is evident that there exists a parameter δ for which the computed displacement discontinuity on faults and the displacement, strain and stress fields at observation points scale linearly with the imposed far field stress. In other words, as in Equation (30):

$$\{ \begin{matrix}δ {σ}_{R} ⇒ δ {b}_{e} \\ δ {σ}_{R} ⇒ δ {u}_{P} \\ δ {σ}_{R} ⇒ δ {ɛ}_{P} \\ δ {σ}_{R} ⇒ δ {σ}_{P}\end{matrix} \qquad ( 30 )$$

This leads to the following property: p Property 1: Scaling the far field stress by δ ∈ [symbol] scales the displacement discontinuity on faults as well as the displacement, strain, and stress fields at observation points by δ.

Using this property, measurements at data points are globally normalized before any computation and the scaling factor is noted (the simulations are also normalized, but the scaling factor is irrelevant). After the system is solved, the recovered far field stress, displacement and stress fields are scaled back by a factor of δₘ⁻¹.

Using GPS Data

In the case of a GPS data set, the cost function is defined in Equation (31):

$${f}_{gps} ( {α}_{1} , {α}_{2} , {α}_{3} ) = \frac{1}{2 m} {\sum }_{P} {[ {( 1 - \frac{{\vec{u}}_{P}^{m} \cdot {\vec{u}}_{P}^{c}}{‖ {\vec{u}}_{P}^{c} ‖ ‖ {\vec{u}}_{P}^{m} ‖} )}^{2} + {( 1 - \frac{‖ {\vec{u}}_{P}^{m} ‖}{‖ {\vec{u}}_{P}^{c} ‖} )}^{2} {( {\vec{u}}_{P}^{c} - {\vec{u}}_{P}^{m} )}^{2} ]}^{1 / 2} \qquad ( 31 )$$

where \vec{u}ₚ^{m} is the globally normalized measured elevation changed at point P from the horizon, and \vec{μ}ₚ^{c} is the globally normalized computed elevation change for a given set of parameters (α₁, α₂, α₃). The first term on the right hand side in Equation (31) represents a minimization of the angle between the two displacement vectors, whereas the second term represents a minimization of the difference of the norm.

Using InSAR Data

When using an InSAR data set, there are two possibilities. Either the global displacement vectors of the measures are computed using the displacement u along the direction of the satellite line of sight \vec{s}, in which case Equation (32) is used:

\vec{μ}ₚ^{m}=\vec{μ}ᵢₙₛₐᵣ=μ. \vec{s} (32)

and the same procedure that is used for the GPS data set (above) is applied with the computed \vec{μ}ₚ^{c}, or, the computed displacement vectors are computed along the satellite line of sight, in which case Equation (33) is used:

μₚ^{c}=\vec{μ}. \vec{s} (33)

where “.” is the dot product. The cost function is consequently given by Equation (34):

$${f}_{insar} ( {α}_{1} , {α}_{2} , {α}_{3} ) = \frac{1}{m} {\sum }_{P} {( 1 - {( \frac{{u}_{P}^{c}}{{u}_{P}^{m}} )}^{2} )}^{1 / 2} \qquad ( 34 )$$

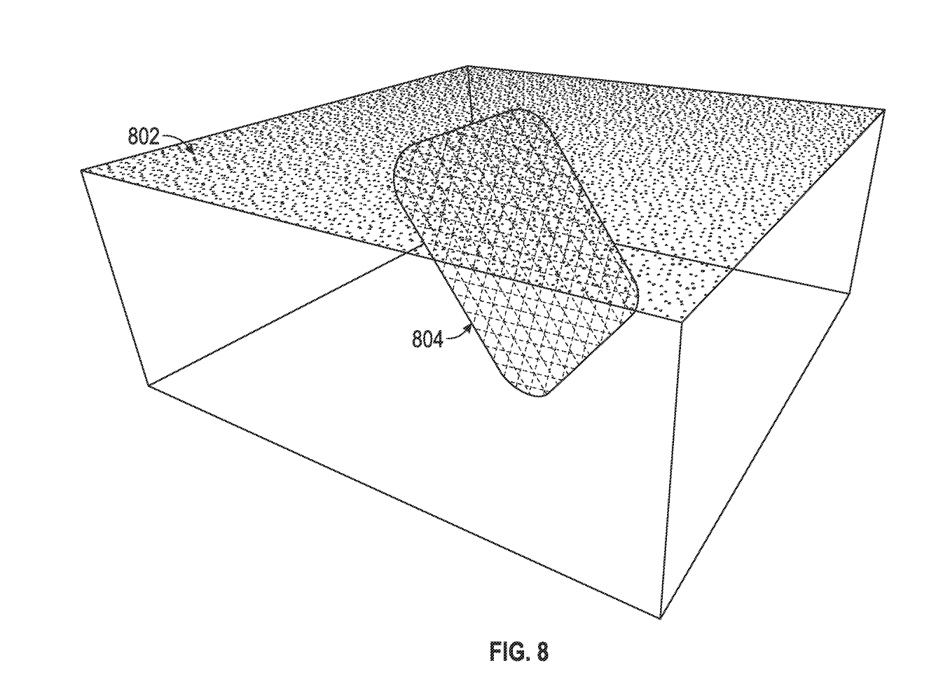

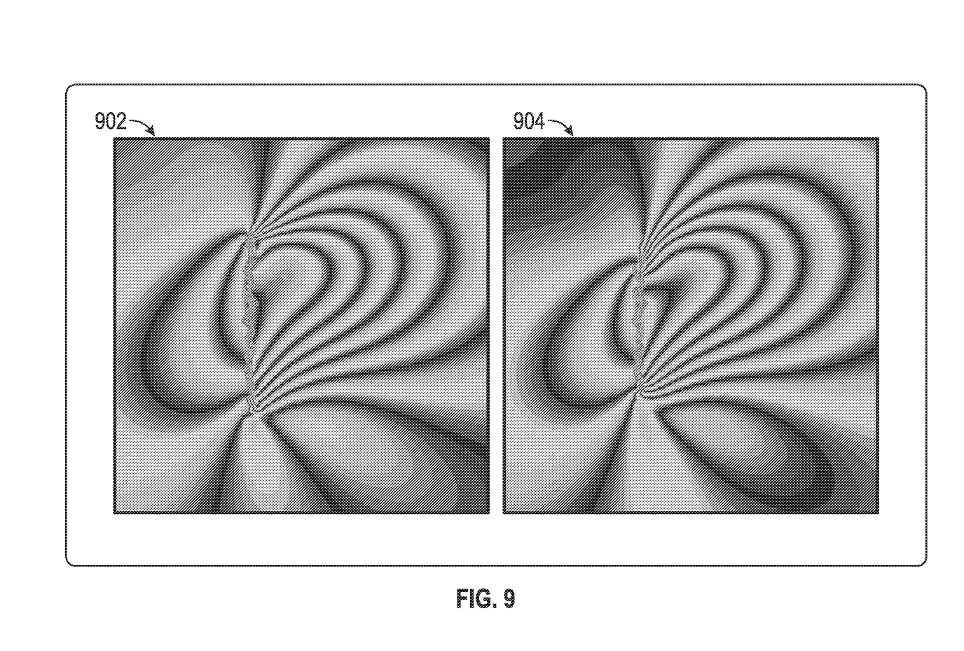

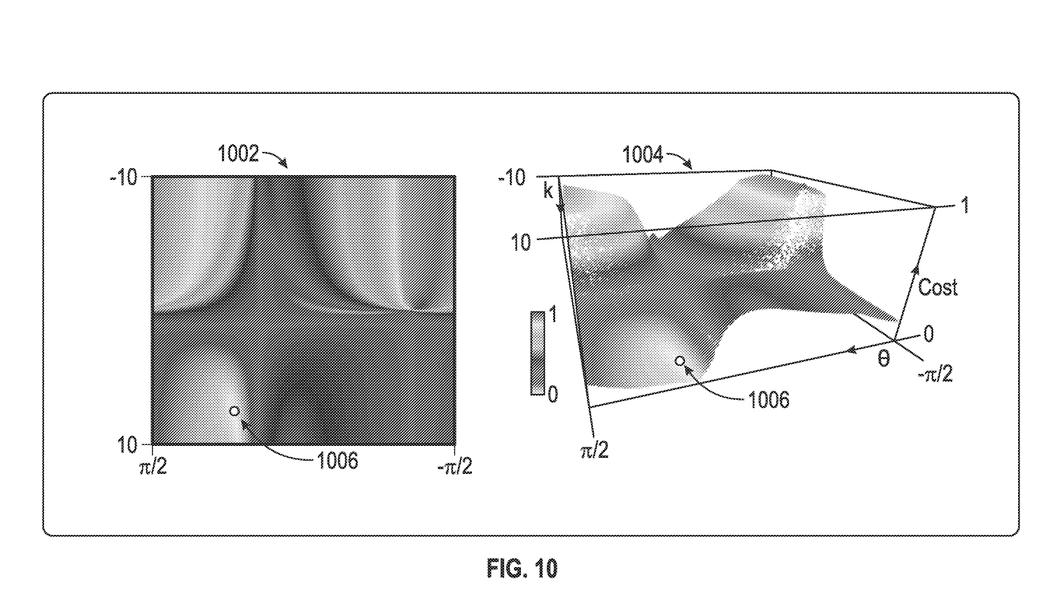

FIGS. 8, 9, and 10 present a synthetic example using an InSAR data set. More particularly, FIG. 8 shows a model configuration showing the InSAR data points 802 as well as the fault surface 804, FIG. 9 shows a comparison of the fringes from the original InSAR grid 902 and the recovered InSAR grid 904, and FIG. 10 shows a plot of the cost surface, as a function of θ (x-axis) and k (y-axis), according to one or more embodiments disclosed. On the left is a top view 1002 of the plot, and on the right is a front perspective view 1004 of the plot. The minimized cost solution 1006 in each view is marked by a small white circle (1006).

To utilize an InSAR data set, a forward model is run using one fault plane 804 and one observation grid (FIG. 8) at the surface of the half-space (see surface holding the data points 802). A satellite direction is selected, and for each observation point 802, the displacement along the satellite line of sight is computed. Then, the stress and fracture modeling method described herein is applied using the second form of the InSAR cost function given in Equation (34). FIG. 9 compares the original interferogram 902 (left) to the recovered interferogram 904 (right). FIG. 10 shows how complex the cost surface can be, even for a simple synthetic model. In one implementation, the cost surface was sampled with 500,000 data points 802 (number of simulations), and took 18 seconds on an average laptop computer with a 2 GHz processor and with 2 GB of RAM running on Linux Ubuntu version 8.10, 32 bits.

Using a Flattened Horizon

Using the mean plane of a given seismic horizon (flattened horizon), the stress and fracture modeling engine 102 first computes the change in elevation for each point making the horizon. Then, the GPS cost function can used, for which the u_{z} component is provided, giving Equation (35):

$${f}_{horizon} ( {α}_{1} , {α}_{2} , {α}_{3} ) = \frac{1}{m} {\sum }_{P} {( 1 - {( \frac{{u}_{P}^{c}}{{u}_{P}^{m}} )}^{2} )}^{1 / 2} \qquad ( 35 )$$

If pre- or post-folding of the area is observed, the mean plane can no longer be used as a proxy. Therefore, a smooth and continuous fitting surface has to be constructed which removes the faulting deformations while keeping the folds. Then, the same procedure as for the mean plane can be used to estimate the paleostress. In some circumstances and prior to defining the continuous fitting surface, the input horizon can be filtered from noises possessing high frequencies, such as corrugations and bumps, while preserving natural deformations.

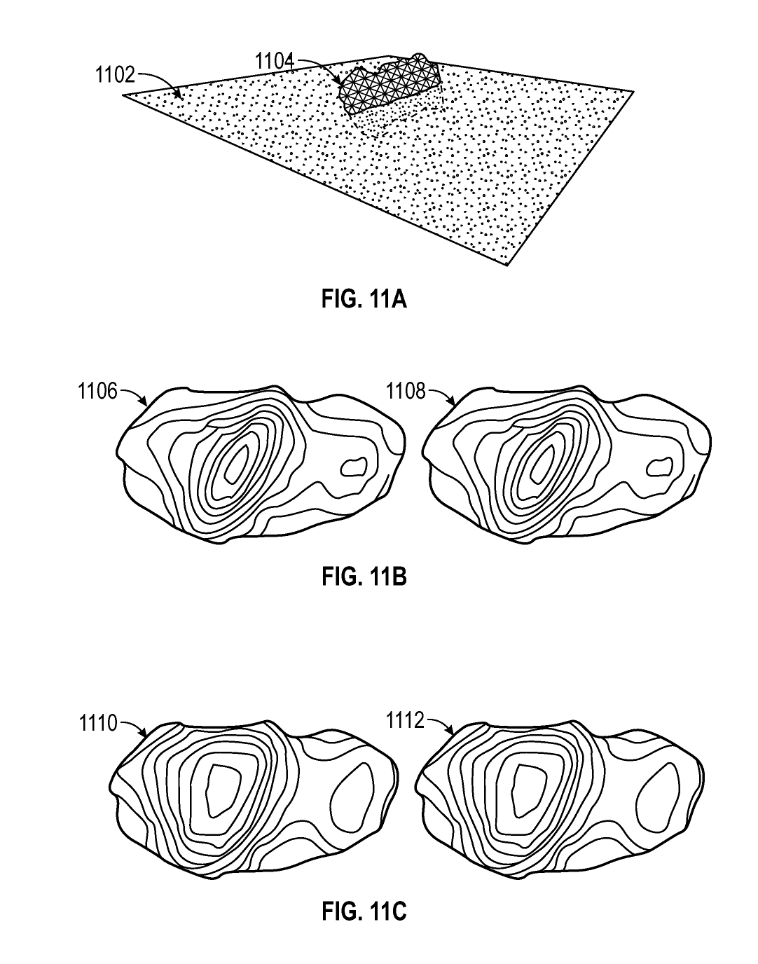

FIG. 11 shows results when applying a stress and fracture modeling method to a synthetic example using a flattened horizon, according to one or more embodiments disclosed. FIG. 11A presents a model configuration showing the horizon 1102 and the fault surface 1104. FIG. 11B shows a comparison of the original dip-slip 1106 (left) and the recovered dip-slip 1108 (right). FIG. 11C shows a comparison of the original strike-slip 1110 (left) and the recovered strike-slip 1112 (right). FIG. 11D shows original vertical displacement 1114 (left) from the flattened horizon (left) and recovered vertical displacement 1116 (right) from the flattened horizon.

As shown in FIG. 11, a complex shaped fault is initially constrained by a far field stress, and consequently slips to accommodate the remote stress. At each point of an observation plane cross-cutting the fault, the stress and fracture modeling engine 102 computes the resulting displacement vector and deforms the grid accordingly. Then, inversion takes place using the fault geometry. After flattening the deformed grid, the change in elevation for each point is used to constrain the inversion and to recover the previously imposed far field stress as well as the fault slip and the displacement field. The comparison of the original and inverted dip-slip (FIG. 11B) and strike-slip (FIG. 11C) show that they match well (same scale). A good match is also observed for the displacement field at the observation grid (FIG. 11D).

Using Dip-Slip Information

When dip-slip data is used, the cost function is defined as in Equation (36):

$${f}_{ds} ( {α}_{1} , {α}_{2} , {α}_{3} ) = \frac{1}{m} {\sum }_{P} {( 1 - {( \frac{{b}_{e}^{c}}{{b}_{e}^{m}} )}^{2} )}^{1 / 2} \qquad ( 36 )$$

where bₑ^{m} is the measured dip-slip magnitude for a triangular element e, and bₑ^{c} is the computed dip-slip magnitude.

Using Available Information

The stress and fracture modeling engine 102 can combine the previously described cost functions to better constrain stress inversion using available data (e.g., fault and fracture plane orientation data, GPS data, InSAR data, flattened horizons data, dip-slip measurements from seismic reflection, fault striations, etc.). Furthermore, data can be weighted differently, and each datum can also support a weight for each coordinate.

Multiple Tectonic Events

For multiple tectonic events, it is possible to recover the major ones, e.g., those for which the tectonic regime and/or the orientation and/or magnitude are noticeably different. Algorithm 2, below, presents a way to determine different events from fracture orientation (joints, stylolites, conjugate fault planes) measured along wellbores.

After doing a first simulation, a cost is attached at each observation point which shows the confidence of the recovered tectonic stress relative to the data attached to that observation point. A cost of zero means a good confidence, while a cost of one means a bad confidence. See FIG. 7 for an example plot of the cost. By selecting data points that are under a given threshold value and running another simulation with these points, it is possible to extract a more precise paleostress value. Then, the remaining data points above the threshold value can be used to run another simulation with the paleostress state to recover another tectonic event. If the graph of the new cost shows disparities, the example method above is repeated until satisfactory results are achieved. During the determination of the tectonic phases, the observation points are classified in their respective tectonic event. However, the chronology of the tectonic phases remains undetermined.

ALGORITHM (2): Detecting Multiple Tectonic Events

Input: ∈ as a user threshold in [0, 1]
Input: S = all fractures from all wells
Let: T = Ø
while S ≠ Ø do

Simulations: Compute the cost for each fracture in S
if max(cost) < ∈ then

Detect a tectonic event σ_{R} for fractures in S
if T = Ø then

Terminate

else

S = T
T = Ø
continue

end
S = fractures below ∈
T + = fractures above ∈

end

Seismic Interpretation Quality Control

It can be useful to have a method for quality control (QC) for interpreted faults geometries from seismic interpretation. The fracture orientations from wellbores can be used to recover the far field stress and the displacement discontinuities on active faults. Then, the computed displacement field is used to deform the initially flattened horizons. The geometry of the resulting deformed horizons can be compared with the interpreted ones. If some mismatches are clearly identified (e.g., interpreted uplift and computed subsidence), then the fault interpretation is possibly false. For example, an interpreted fault might dip in the wrong direction. An unfolded horizon can be approximated by its mean plane, as described above in relation to flattened horizons.

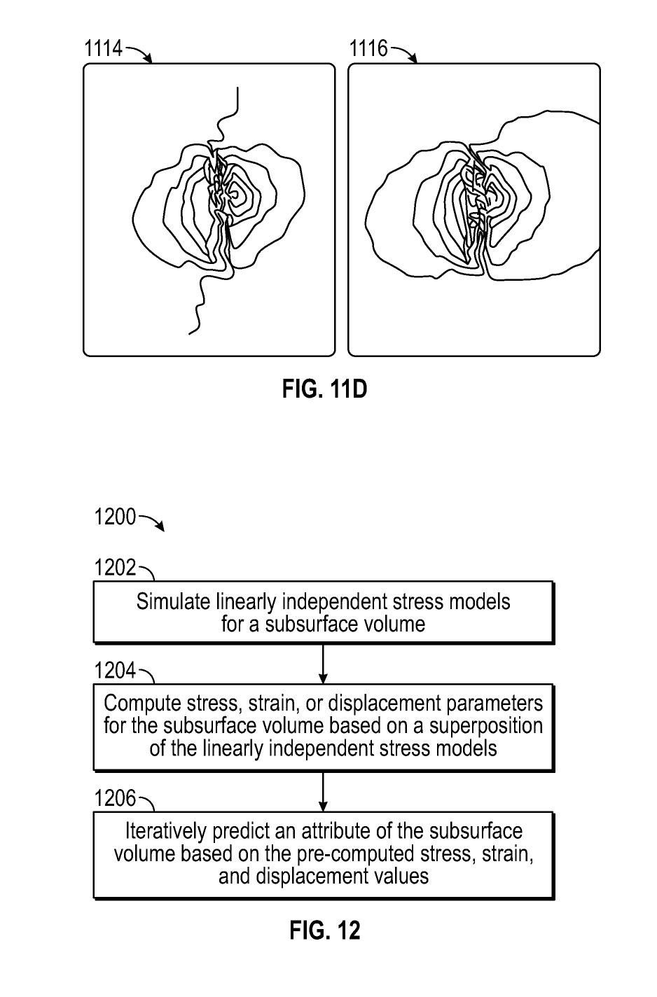

FIG. 12 shows a method 1200 of stress and fracture modeling using the principle of superposition, according to one or more embodiments disclosed. The example method 1200 may be performed by hardware or combinations of hardware and software, for example, by the example stress and fracture modeling engine.

Linearly independent stress models for a subsurface volume can be simulated, as shown at 1202.

Stress, strain, and/or displacement parameters for the subsurface volume can be computed, based on a superposition of the linearly independent stress models, as shown at 1204.

An attribute of the subsurface volume can be iteratively predicted based on the precomputed stress, strain, and/or displacement values, as shown at 1206.

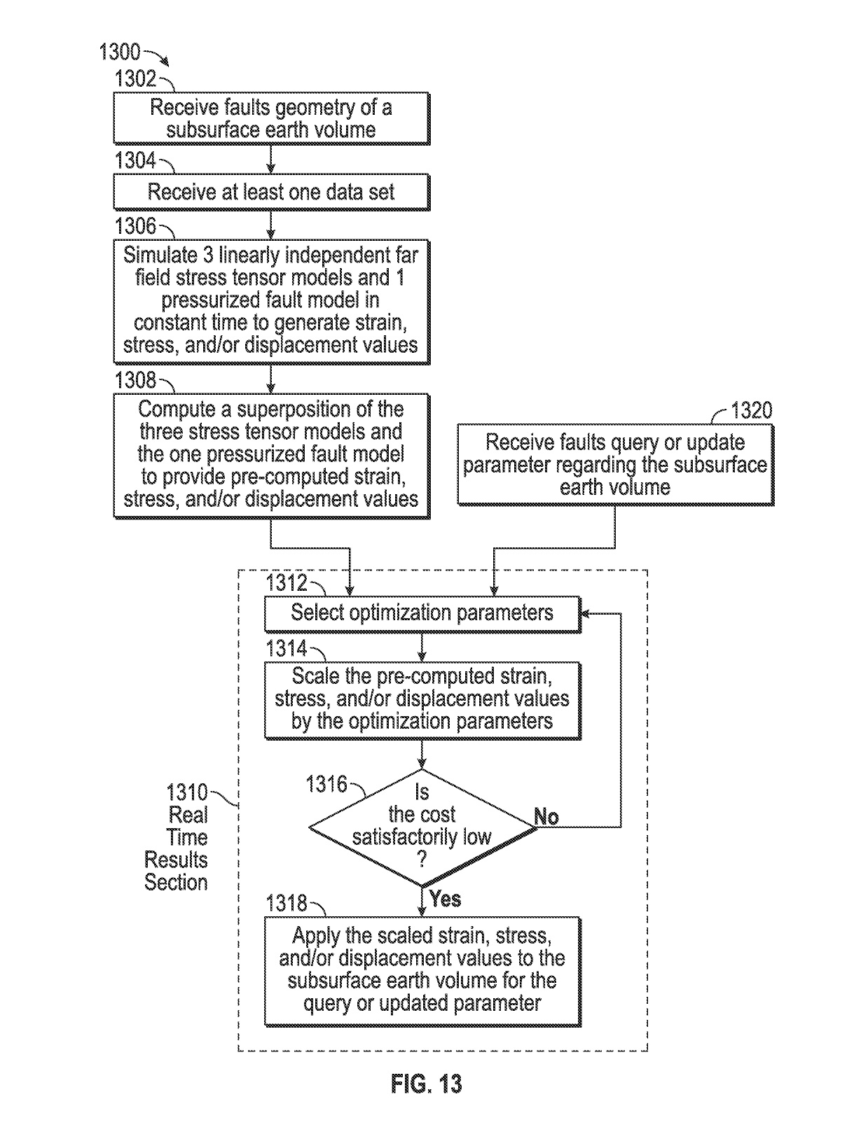

FIG. 13 shows a method 1300 of stress and fracture modeling using the principle of superposition, according to one or more embodiments disclosed. The method 1300 may be performed by hardware or combinations of hardware and software, for example, by the stress and fracture modeling engine 102.

Faults geometry for a subsurface earth volume can be received, as shown at 1302.

At least one data set associated with the subsurface earth volume can also be received, as shown at 1304.

One or more (e.g., three) linearly independent far field stress tensor models and one or more (e.g., one) discontinuity pressure models can be simulated in constant time to generate strain, stress, and/or displacement values, as shown at 1306. The discontinuity pressure model can be or include a model of a fault, dyke, salt dome, magma chamber, or a combination thereof.

A superposition of the three linearly independent far field stress tensor models and the discontinuity pressure model can be computed to provide precomputed strain, stress, and/or displacement values, as shown at 1308.

A post-process segment of the method can commence, that can compute numerous real-time results based on the principle of superposition, as shown at 1310. This can involve inversion of the one or more linearly independent far field stress models and/or the one or more discontinuity pressure models.

Optimization parameters for each of the linearly independent far field stress tensor models and fault pressure can be selected, as shown at 1312

The precomputed stress, strain, and/or displacement values can be scaled by the optimization parameters, as shown by 1314

A cost associated with the scaled precomputed stress, strain, and/or displacement values can be evaluated, as shown by 1316. If the cost is not satisfactory, then the method loops back to 1312 to select new optimization parameters. If the cost is satisfactory, then the method continues to 1318.

The scaled strain, stress, and/or displacement values can be applied to the subsurface earth volume, e.g., with respect to a query about the subsurface earth volume or in response to an updated parameter about the subsurface earth volume, as shown by 1318.

A fault(s) query and/or updated parameter regarding the subsurface earth volume can be received, that seeds or initiates generation of the post-process results in the real-time results section (1310), as shown by 1320.

Based on the solution of an angular dislocation in a 3D homogeneous isotropic elastic whole- or half-space, the pressure inside discontinuities (e.g., faults, dykes, salt domes, magma chambers) and the regional stress regime (e.g., orientation of the maximum principal horizontal stress according to North) can be inverted. The stress ratio can be defined as in Equation (37):

R=(σ₂-σ₃)/(σ₁-σ₃) (37)

Pressure can be inverted relative to the maximum shear stress (σ₁-σ₃), e.g., the difference between maximum and minimum principal inverted regional stress. Equation (38) shows the relationship between the real pressure and the normalized inverted pressure:

p= p̅/(σ₁-σ₃) (38)

where p̅ represents the real pressure and p the normalized inverted pressure.

Three dimensional discontinuities making the cavities, faults, and/or salt domes can be discretized as complex 3D triangular surfaces. To constrain the inversion, at least a portion of the data can be used and combined together such as any fracture orientation (e.g., joints, stylolites) or wellbore ovalization, GPS or InSAR data, microsismicity or focal mechanisms with or without magnitude information, tiltmeters, or the like. 4 preliminary simulation results at data points are used to invert for both the pressure and the regional stress. The transformation matrix from the 4 solutions and the linear coefficient to a given far field stress is given by Equation (39):

$$[ \begin{matrix}{σ}_{xx}^{1} & {σ}_{xx}^{2} & {σ}_{xx}^{3} & 0 \\ {σ}_{xy}^{1} & {σ}_{xy}^{2} & {σ}_{xy}^{3} & 0 \\ {σ}_{yy}^{1} & {σ}_{yy}^{2} & {σ}_{yy}^{3} & 0 \\ 0 & 0 & 0 & {p}_{0}\end{matrix} ] α = A α = \{ \begin{matrix}{σ}_{xx} \\ {σ}_{xy} \\ {σ}_{yy} \\ Pp\end{matrix} \} = {σ}_{R} \qquad ( 39 )$$

where σₓₓⁱ, σ_{xy}ⁱ and σ_{yy}ⁱ represent the regional stress parameters for simulation i ∈ [0,3] and for which the perturbed stress and displacement fields at data are computed and stored. p₀ is a pressure (different from 0) and for which the perturbed stress and displacement fields at data are computed and stored.

Thus, for a given remote stress and fault pressure p,

$${σ}_{R} = \{ \begin{matrix}{σ}_{xx} \\ {σ}_{xy} \\ {σ}_{yy} \\ p\end{matrix} \} ,$$

coefficients α={α₁, α₂, α₃, α₄}^{T} are computed from Equation (39) using α=A⁻¹σ_{R}. The perturbed stress, strain, and/or displacement at a point P can be given by the linear combination of the stored solutions at p using the same coefficients a. This can be used to find the best a, and therefore to invert for both the regional stress and the pressure using Equation (39).

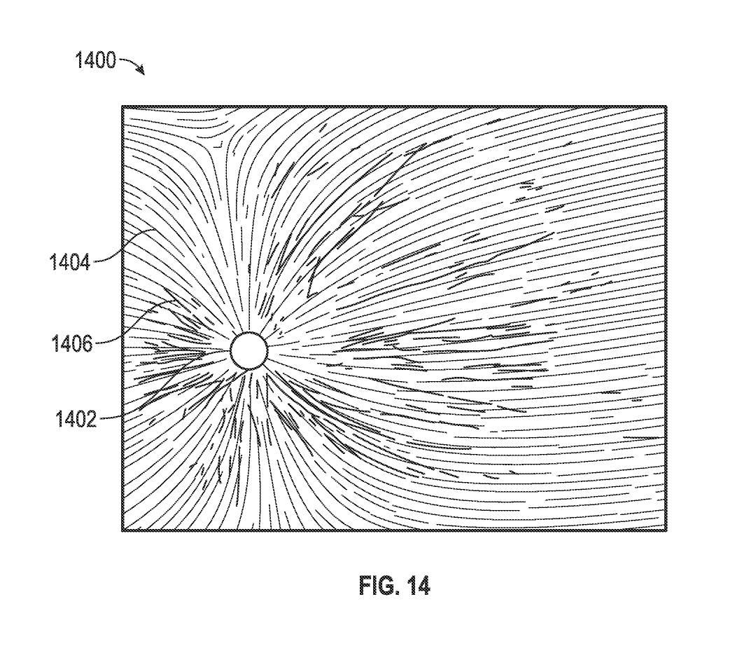

FIG. 14 illustrates a model 1400 showing dykes orientations from inversion of the pressure inside a vertical plug 1402, according to one or more embodiments disclosed. The model 1400 is in half-space with no rigid boundary. The thin lines 1404 represent the predicted dykes orientation, and the thick lines 1406 represent the observed dykes orientation. The inverted stress regime gives R=0.04 in the normal fault regime with θ=N81E for the orientation. The inverted normalized pressure is 1.4. In other words, the inverted normalized pressure is 1.4 times greater than (σ₁-σ₃).

Conclusion and Perspectives

The stress and fracture modeling engine 102 applies the property of superposition that is inherent to linear elasticity to execute real-time computation of the perturbed stress and displacement field around a complexly faulted area, as well as the displacement discontinuity on faults. Furthermore, the formulation executed by the stress and fracture modeling engine 102 enables rapid paleostress inversion using multiple types of data such as fracture orientation, secondary fault planes, GPS, InSAR, fault throw, and fault slickenlines. In one implementation, using fracture orientation and/or secondary fault planes from wellbores, the stress and fracture modeling engine 102 recovers one or more tectonic events, and the recovered stress tensor are given by the orientation and ratio of the principal magnitudes. The stress and fracture modeling engine 102 can be applied across a broad range of applications, including stress interpolation in a complexly faulted reservoir, fractures prediction, quality control on interpreted faults, real-time computation of perturbed stress and displacement fields while doing interactive parameter estimation, fracture prediction, discernment of induced fracturing from preexisting fractures, and so forth.

Another application of the stress and fracture modeling engine 102 is evaluation of the perturbed stress field (and therefore the tectonic event(s)) for recovering “shale gas.” Since shale has low matrix permeability, fractures are used to provide permeability to produce gas production in commercial quantities. This is oftentimes done by hydraulic fracturing to create extensive artificial fractures around wellbores.

The steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method for predicting a stress attribute of a subsurface earth volume, comprising:
simulating one or more linearly independent far field stress models and one or more discontinuity pressure models for the subsurface earth volume to generate stress values, strain values, displacement values, or a combination thereof for data points in the subsurface earth volume;
computing, using a processor, a superposition of the one or more linearly independent far field stress models and the one or more discontinuity pressure models; and
predicting the stress attribute of the subsurface earth volume, based on the computed stress values, strain values, displacement values, or the combination thereof.

2. The method of claim 1, further comprising inverting, using the processor, the one or more linearly independent far field stress models.

3. The method of claim 1, further comprising inverting, using the processor, the one or more discontinuity pressure models.

4. The method of claim 3, wherein the one or more discontinuity pressure models is inverted relative to a difference between a maximum principal inverted regional stress and a minimum principal inverted regional stress.

5. The method of claim 3, wherein one or more the discontinuity pressure models is inverted based at least partially on an angular dislocation in a three dimensional isotropic elastic whole-space or a three dimensional isotropic elastic half-space.

6. The method of claim 1, wherein the one or more discontinuity pressure models comprises a pressure model of a fault, a dyke, a magma chamber, a salt dome, or a combination thereof.

7. The method of claim 1, further comprising minimizing a cost function to determine one or more optimization parameters for predicting the stress attribute.

8. The method of claim 7, wherein predicting the stress attribute of the subsurface earth volume further comprises applying the one or more optimization parameters to the computed stress values, strain values, displacement values, or the combination thereof.

9. The method of claim 1, wherein the one or more linearly independent far field stress models comprise three linearly independent far field stress models that are based on different data sets, each data set comprising fault geometry data, fracture orientation data, stylolites orientation data, secondary fault plane data, fault throw data, slickenline data, global positioning system (GPS) data, interferometric synthetic aperture radar (InS AR) data, laser ranging data, tilt-meter data, displacement data for a geologic fault, stress magnitude data for the geologic fault, or a combination thereof.

10. The method of claim 1, wherein the predicted stress attribute comprises one of a stress inversion, a stress field, a far field stress value, a stress interpolation in a complex faulted reservoir, a perturbed stress field, a stress ratio and associated orientation, one or more tectonic events, a displacement discontinuity of a fault, a fault slip, an estimated displacement, a perturbed strain, a slip distribution on faults, quality control on interpreted faults, fracture prediction, prediction of fracture propagation according to perturbed stress field, real-time computation of perturbed stress and displacement fields while performing interactive parameters estimation, or discernment of an induced fracture from a preexisting fracture.

11. A computer readable medium storing instructions thereon that, when executed by a processor, are configured to cause the processor to perform operations, the operations comprising:
simulating one or more linearly independent far field stress models and one or more discontinuity pressure models for a subsurface earth volume to generate stress values, strain values, displacement values, or a combination thereof for data points in the subsurface earth volume;
computing, using the processor, a superposition of the one or more linearly independent far field stress models and the one or more discontinuity pressure models; and
predicting a stress attribute of the subsurface earth volume, based on the computed stress values, strain values, displacement values, or the combination thereof.

12. The computer readable medium of claim 11, wherein the operations further comprise inverting, using the processor, the one or more linearly independent far field stress models and the one or more discontinuity pressure models.

13. The computer readable medium of claim 12, wherein the one or more discontinuity pressure models is inverted relative to a difference between a maximum principal inverted regional stress and a minimum principal inverted regional stress.

14. The computer readable medium of claim 12, wherein one or more the discontinuity pressure models is inverted based at least partially on an angular dislocation in a three dimensional isotropic elastic whole-space or a three dimensional isotropic elastic half-space.

15. The computer readable medium of claim 11, wherein the one or more discontinuity pressure models comprises a pressure model of a fault, a dyke, a magma chamber, a salt dome, or a combination thereof.

16. A computing system, comprising:
a processor; and
a memory system comprising one or more non-transitory computer readable media storing instructions thereon that, when executed by the processor, are configured to cause the computing system to perform operations, the operations comprising:
simulating one or more linearly independent far field stress models and one or more discontinuity pressure models for a subsurface earth volume to generate stress values, strain values, displacement values, or a combination thereof for data points in the subsurface earth volume;
computing, using the processor, a superposition of the one or more linearly independent far field stress models and the one or more discontinuity pressure models; and
predicting a stress attribute of the subsurface earth volume, based on the computed stress values, strain values, displacement values, or the combination thereof.

17. The computing system of claim 16, wherein the operations further comprise inverting, using the processor, the one or more linearly independent far field stress models and the one or more discontinuity pressure models.

18. The computing system of claim 17, wherein the one or more discontinuity pressure models is inverted relative to a difference between a maximum principal inverted regional stress and a minimum principal inverted regional stress.

19. The computing system of claim 17, wherein one or more the discontinuity pressure models is inverted based at least partially on an angular dislocation in a three dimensional isotropic elastic whole-space or a three dimensional isotropic elastic half-space.

20. The computing system of claim 16, wherein the one or more discontinuity pressure models comprises a pressure model of a fault, a dyke, a magma chamber, a salt dome, or a combination thereof.
